(19) United States
(12) Patent Application Publication
(10) Pub. No.: US 2004/0057818 A1
(43) Pub. Date: Mar. 25, 2004

(54) MODULAR BULK MATERIAL UNLOADING PIT

(76) Inventor: Thomas W. Hedrick, Sikeston, MO (US)

Correspondence Address: Paul M. Denk, 763 South New Ballas Road, St. Louis, MO, 63141, US

(21) Appl. No.: 10/253,013

(22) Filed: Sep. 24, 2002

(51) Int. Cl. B65G 65/00

(52) U.S. Cl. 414/293

(57) ABSTRACT

A modular pit fabricated from metallic components having a rail assembly crossing thereover, various beams and crossbeams provided across the top of the pit generally in alignment with the rail frame assembly, and a transfer screw conveyor, mounted upon structural supports, at an incline from beneath the rail assembly and its unloading area, to a position-exteriorly of the pit to provide for unloading and conveyance of granular material such as cement, coal, or any other type of flowable material.

### BACKGROUND OF THE INVENTION

In the past, conventional rail pit construction was difficult, expensive and time consuming process. Rail pits were commonly built using concrete walls and floors that had to be located, formed, poured, allowed to set, and the forms removed. After the forms were removed, the excavated hole had to be backfilled and the backfill compacted. Next, the rail support substructure and material handling conveyers were built on top of the curved concrete walls and the rail tracks reinstalled. Because every pit installation has differing requirements and configurations, each pit had to be separately designed and appropriate plans drawn.

The present invention solves the problems associated with the prior art by speeding and simplifying the process of building a rail pit. The present invention provides two preassembled units, a pit box assembly and a rail frame assembly, which can be quickly attached and installed in a number of configurations and do not require further assembly at a construction location. Further, the present invention eliminates the need for concrete forms, thereby eliminating the associated labor of constructing and removing concrete forms and the need to wait for the concrete walls to set before pit construction can continue.

### SUMMARY OF THE INVENTION

In its broadest aspect the present invention provides a bulk material unloading pit comprising a slab concrete base, a preassembled pit box assembly, a preassembled rail frame assembly, a gathering conveyor and a transfer conveyor. The preassembled pit box assembly comprises exterior walls and a top surface covering at least a portion of the pit box assembly to allow heavy equipment to drive over the top of the pit box assembly. The preassembled rail frame assembly comprises at least two beams and a deck plate defining at least two cutout sections over which boot lifts are mounted. The gathering conveyor is attached to the preassembled rail frame. The transfer conveyor is mounted within the pit box assembly. The pit box assembly, rail frame assembly, the gathering conveyor and the transfer conveyor are configured such that bulk material dropped through either of the two cutout sections is transferred to the gathering conveyor which subsequently transfers the bulk material to the transfer conveyor.

A second broad aspect of the present invention provides a method of installing a modular bulk material unloading pit into an existing length of railroad track comprising the steps of removing a section of rail under which the modular pit will be located, excavating a hole in which the modular pit will be located, pouring a concrete slab upon which the modular pit will be located, placing a pit box assembly on the concrete slab, backfilling the hole around the pit box assembly, locating a rail frame assembly under the removed section of rail, attaching the rail frame assembly to the pit box assembly, and attaching rail to the rail frame assembly in place of the removed section of rail.

### DESCRIPTION OF THE DRAWINGS

FIG. 1 is a top view of a modular pit according to an embodiment of the present invention;

FIG. 2 is a sectional view of a modular pit according to an embodiment of the present invention;

FIG. 3 is a sectional view of a rail frame assembly of a modular pit according to an embodiment of the present invention;

FIG. 4 is a front sectional view of an installed modular pit according to an embodiment of the present invention;

FIG. 5 is a right side sectional view of an installed modular pit according to an embodiment of the present invention having a rail car positioned over the modular pit;

FIG. 6 is a sectional view of an installed rail frame assembly according to an embodiment of the present invention; and

FIG. 7 is a sectional view of a I-beam of a rail frame assembly having a rail attached thereto by rail clips according to an embodiment of the present invention.

### DETAILED DESCRIPTION OF THE PREFERRED EMBODIMENT

While the invention is susceptible of embodiment in many different forms, there is shown in the drawings and will herein be described in detail the preferred embodiment of the invention. It is to be understood that the present disclosure is to be considered only as an example of the principles of the invention. This disclosure is not intended to limit the broad aspect of the invention to the illustrated embodiment.

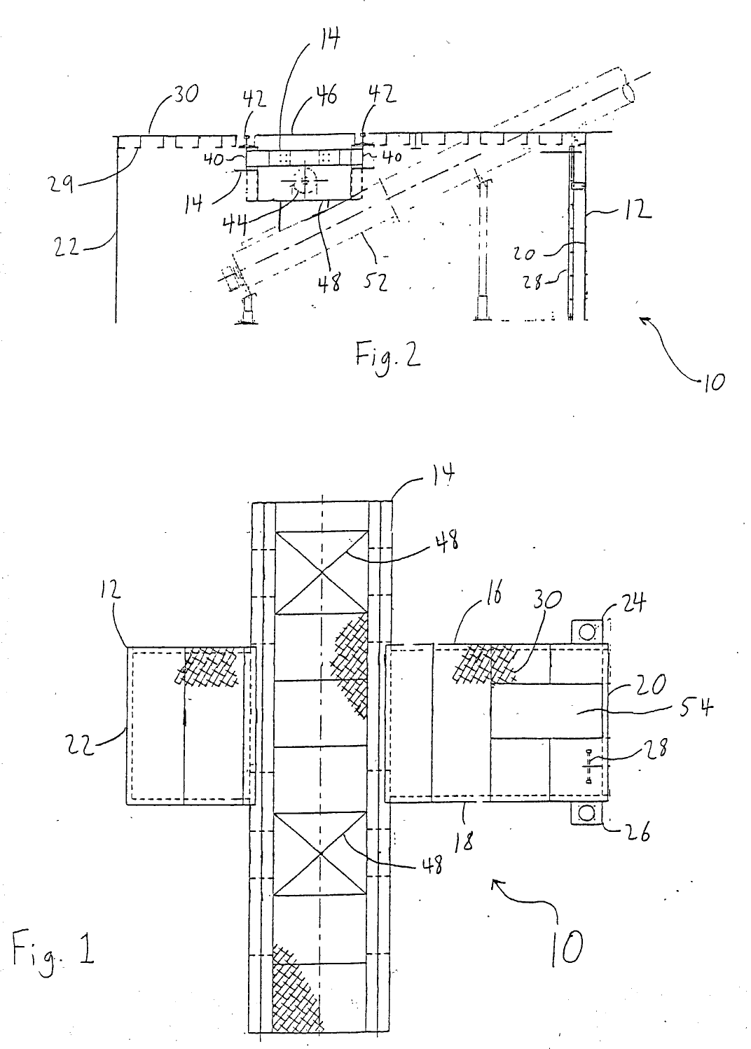

Referring to FIGS. 1 and 2, there is shown a modular pit 10 according to the present invention. The modular pit 10 generally comprises two main sections: a pit box assembly 12 and a rail frame assembly 14. The pit box assembly 12 comprises four steel walls 16, 18, 20, 22. Attached to walls 16 and 18 are two boot lift control consoles 24, 26 for boot lift height control circuitry. Also, attached to the pit box assembly 12 is a ladder 28 for gaining access to the interior of the pit box assembly 12. Attached to the top of the walls 16 and 18 are steel crossbeams 29 and grating 30 (partially shown) of suitable stability heavy equipment and trucks driving over the pit box assembly 12. The grating 30 is preferably steel grating and comprises several sections that may be individually removed and replaced in order to gain access to the interior of the pit box assembly 12. The steel crossbeams 29 also provide additional stability to the pit box assembly 12.

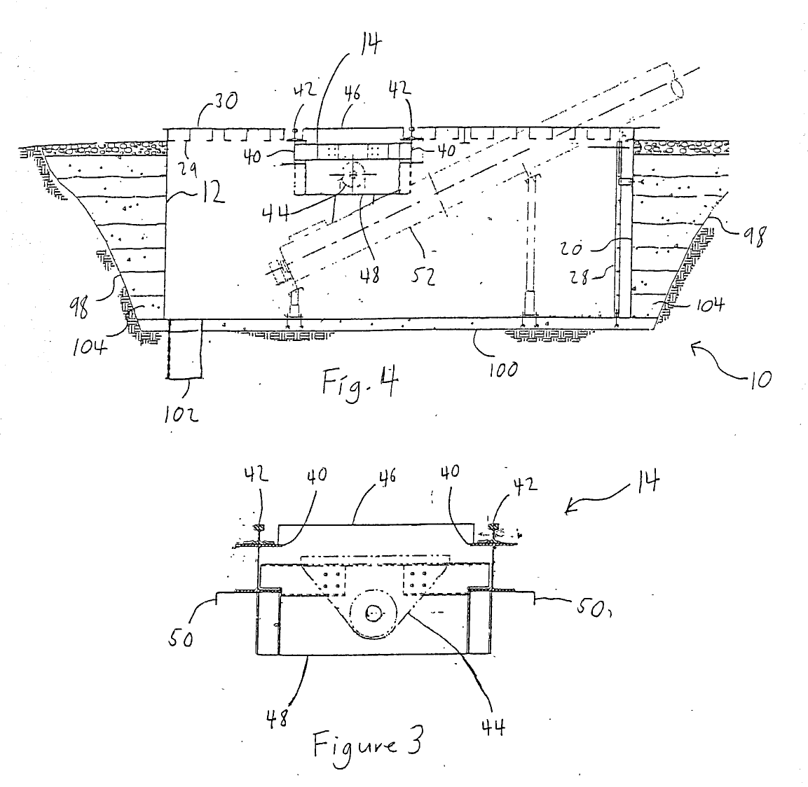

Referring now to FIGS. 1 and 3, the rail frame assembly 14 comprises two I-beams 40, each attached to a rail 42. Connecting the two I-beams 40 is a gathering screw conveyor 44 and a deck plate 46. Attached to a bottom of each I-beam 40 is a bottom cover assembly 48 and anchor traps 50. The deck plate 46 defines two cutout sections 48 over which a boot lift will be mounted (as described below). An advantage of the present invention is that the rails 42 do not have to be removed in order to remove and replace the gathering screw conveyor 44 once the deck plate 46 has been removed.

Referring to FIG. 2, a transfer screw conveyor 52 is mounted within the pit box assembly 12 and is attached to the gathering screw conveyor 44. The transfer screw conveyor 52 is mounted through a transfer screw conveyor access opening 54 (FIG. 1) in the grating 30.

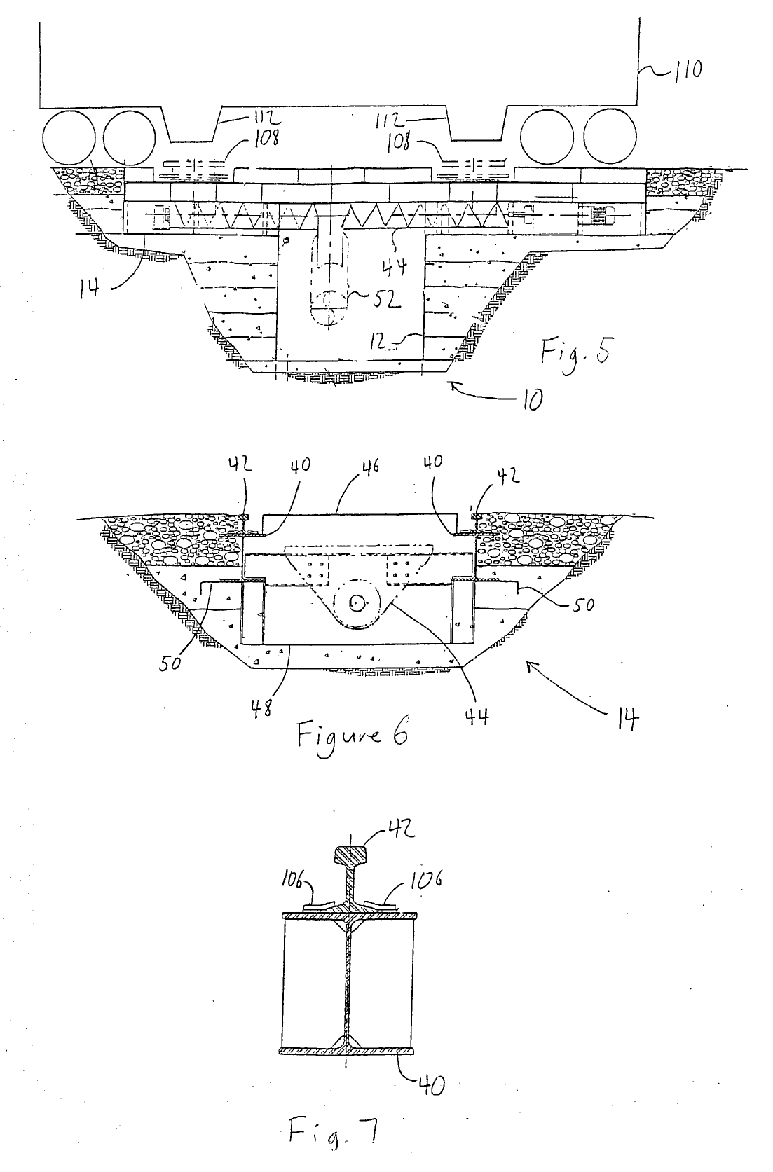

Referring to FIGS. 4, 5 and 6, the modular pit 10 is installed by removing a section of rail (not shown) under which the modular pit 10 will be located. Next, hole 98 is excavated in which the modular pit 10 will be located. In the excavated hole, a concrete floor 100 is poured and sloped toward a sump pump tank 102. Once the concrete floor 100 has set up, the pit box assembly 12 is placed on the floor 100 and shimmed until the pit box assembly 12 is level. Next the hole 98 is backfilled with concrete in 12 inch lifts 104 allowing each lift to set up to a degree before pouring the next lift 104. When the lifts 104 reach the elevation of bottom of the rail frame assembly 14, the pit box assembly 12 is field cut and the rail frame assembly 14 located and welded under the removed section of rail and within the field cut of the pit box assembly 12. Next, the removed section of rail 42 is reattached to existing rail and welded to the I-beam 40 using rail clips 106, as shown in FIG. 7. After the rail frame assembly 14 is installed, concrete lifts are poured to backfill the hole 98 to near elevation. Once the concrete has set, the hole 98 is backfilled to elevation with rock. Next, the transfer screw conveyor 52 is installed and attached to the gathering screw conveyor 44. Boot lifts 108 (FIG. 5) are installed over the boot lift openings 48, and boot lift control circuitry installed in the boot lift control consoles 24, 26.

Referring to FIG. 5, in operation a rail car 110 is positioned over the boot lift assemblies 108. The boot lift assemblies 108 are raised to attach to rail car discharge chutes 112 and the chutes are 112 opened to allow material to fall into the boot lift assemblies. The gathering screw conveyor 44 is then operated to move the material to the transfer screw conveyor 52. The transfer screw conveyor 52 is then operated to elevate the material to storage structures located outside the modular pit 10.

It will be appreciated by one of ordinary skill in the art that the present invention is not limited to any particular arrangement of the pit box assembly 12 in relation to the rail frame assembly, and that the rail frame assembly 14 may be placed in the pit box assembly 12 at any location or relative angle to accommodate various types and configurations of transfer conveyors 52 and railways. It will similarly be appreciated that the present invention is not limited to any particular type of conveyor system and could include a belt conveyors in place of either screw conveyor 44, 52 as the situation may require.

While a specific embodiment has been illustrated and described, numerous modifications come to mind without significantly departing from the spirit of the invention, and the scope of protection is only limited by the scope of the accompanying claims.

I claim:

1. A bulk material unloading pit comprising:
a slab concrete base;
a preassembled pit box assembly comprising exterior walls and a top surface covering at least a portion of the pit box assembly to allow heavy equipment to drive over the top of the pit box assembly;
a preassembled rail frame assembly comprising at least two beams and a deck plate defining at least two cutout sections over which boot lifts are mounted;
a gathering conveyor attached to the preassembled rail frame;
a transfer conveyor mounted within the pit box assembly; and
wherein the pit box assembly, rail frame assembly, the gathering conveyor and the transfer conveyor are configured such that bulk material dropped through either of the two cutout sections is transferred to the gathering conveyor which subsequently transfers the bulk material to the transfer conveyor.

2. The bulk material-unloading pit of claim 1 further comprising rails attached to two beams of the rail frame assembly.

3. The bulk material unloading pit of claim 2 configured such that the rails do not have to be removed in order to remove and replace the gathering screw conveyor.

4. The bulk material unloading pit of claim 1 wherein two boot lift control consoles containing boot lift height control circuitry for raising and lowering the boot lifts.

5. The bulk material unloading pit of claim 1 wherein the pit box assembly further comprises a ladder for gaining access to the interior of the pit box assembly.

6. The bulk material unloading pit of claim 1 wherein the deck plating comprises steel crossbeams and steel grating and portions of the steel grating may be individually removed to gain access to an interior of the pit box assembly.

7. A method of installing a modular bulk material unloading pit into an existing length of railroad track comprising the steps of:
removing a section of rail under which the modular pit will be located;
excavating a hole in which the modular pit will be located;
pouring a concrete slab upon which the modular pit will be located;
placing a pit box assembly on the concrete slab;
backfilling the hole around the pit box assembly;
locating a rail frame assembly under the removed section of rail;
attaching the rail frame assembly to the pit box assembly; and
attaching rail to the rail frame assembly in place of the removed section of rail.

8. The method of claim 7 wherein the step of attaching rail to the rail frame assembly in place of the removed section of rail further comprises:
attaching rail to the rail frame assembly in place of the removed section of rail using rail clips.

9. The method of claim 7 wherein the step of backfilling the hole around the pit box assembly comprises:
backfilling the hole around the pit box assembly with concrete in lifts.

10. The method of claim 7 wherein the step of locating a rail frame assembly under the removed section of rail further comprises the step of:
locating a rail frame assembly under the removed section of rail having a gathering conveyor attached thereto;
and further comprising the step of:
installing a transfer screw conveyor to the modular pit.

11. The method of claim 7 further comprising the step of installing boot lifts upon the modular pit.

12. The method of claim 7 further comprising the step of cutting the pit box assembly to accommodate the rail frame assembly.
